(19) United States
(12) Patent Application Publication
(10) Pub. No.: US 2006/0193279 A1
(43) Pub. Date: Aug. 31, 2006

(54) Method and system for accessing a channel in a wireless communications network using multi-polling

(76) Inventors: Daqing Gu, Burlington, MA (US); Yue Fang, Quincy, MA (US); Jinyun Zhang, Cambridge, MA (US)

Correspondence Address: Patent Department;Mitsubishi Electric Research Laboratories, Inc., 201 Broadway, Cambridge, MA, 02139, US

(21) Appl. No.: 11/067,255

(22) Filed: Feb. 25, 2005

(51) Int. Cl. H04H 1/00; H04J 3/24

(52) U.S. Cl. 370/312

(57) ABSTRACT

A method and system accesses a wireless channel in a communications network including multiple stations and an access point connected by the wireless channel. The access point periodically broadcasts polling information indicating when a station can transmit. A next station is polled in an acknowledgement message broadcast by the access point in response to receiving data transmitted by a previously polled station.

### FIELD OF THE INVENTION

This invention relates generally to wireless networks, and more particularly access control in wireless networks having a shared channel.

### BACKGROUND OF THE INVENTION

Recent advances in the areas of wireless communications, smart antennas, digital signal processing, and VLSI provide very high capacity wireless channels at a physical (PHY) layer. These technologies offer at least an order-of-magnitude larger bandwidth than is currently available. The IEEE 802.11n standard specifies a throughput of up to 100 Mbps at a media access control (MAC) layer.

However, to deliver 100 Mbps the MAC, a pure PHY layer solution is insufficient due to a significant protocol overhead caused by the conventional MAC layer protocol. Therefore, the MAC layer protocol must be modified before it can be applied to high throughput wireless networks including an access point (AP) and terminals including transceivers, generally stations (STAs). The AP and STAs form a basic service set (BSS).

Standards such as IEEE 802.11 and 802.11e support both contention-based and contention-free channel access mechanisms, namely, distributed coordination function/enhanced distributed coordination function (DCF/EDCF) and pointed coordination function/hybrid coordination function (PCF/HCF), respectively. Particularly, the invention is concerned with HCF controlled channel access.

IEEE 802.11 PCF/IEEE 802.11e HCCA Polling

The IEEE 802.11/11e standard for wireless local area networks (WLANs) uses a polling mechanism to allow the AP to schedule transmissions by the STAs in a contention free period (CFP); each STA can only transmit when it is polled. Thus, there are no hidden terminals and no collisions.

The hidden terminal problem describes a situation in a wireless network with at least three terminals, where at least two terminals nodes cannot communicate with each other because they are out of each other's range. The hidden terminal problem can lead to data collision because both out-of-range terminals can transmit at the same time.

FIG. 1 and FIG. 2 illustrate the IEEE 802.11 PCF 100 and IEEE 802.11e HCCA polling scheme 200, respectively. Frames above a time line 10 are transmitted by the AP and frames below the line 10 are transmitted by the STAs.

During the contention free period 01, the AP controls access to the channel. Thus, CFP 01 refers to the time period that channel access is controlled by the access point (AP) so that there is no contention among the STAs. During the contention period (CP) 102, the STAs contend for channel access according to a carrier-sensing-multiple-access/collision avoidance (CSMA/CA) scheme. FIG. 1 is only concerned with the CFP. As CFP and CP alternate over time, a point inter-frame space (PIFS) 110 is required for the switch from CP to CFP. Frames are separated by a short inter-frame space (SIFS) 111.

At the start of the CFP, the AP transmits a beacon frame 120. This is followed by first data and a D1+Poll frame 121 from the AP to the STA. The STA responds with first user data (U1+ack) frame 123. In subsequent data frames, the STA acknowledges the previous user data frame. This pair of frames is repeated.

The arrow 131 indicates that there was no response from a STA. In this case, the AP waits PIFS before accessing the channel again.

The lower part of FIG. 1 represents the activity of a STA that is not polled. When that station receives the beacon, the STA sets a network allocation vector (NAV) to a CFMax Duration, indicated by the arrow 152. During this period of time, the STA defers 141 access to the channel. When the STA receives the CF-END 124 at time 151, the STA resets the NAV value. Thus, the station is able to compete for channel access.

In FIG. 2, the time period 201 defines the period for IEEE 802.11e hybrid coordination channel access (HCCA). As above, the AP transmits a beacon frame 221, followed by a QoS Poll frame 222. The STA responds with a QoS Data frame 223. The frame QoS Ack 204 transmitted by the AP is defined by the IEEE 802.11e standard. CF-End 205 indicates the end of the CFP. PIFS 211 and SIFS 212 are defined above.

FIG. 3 shows the format of a MAC frame 300. The frame starts with a frame control (FC) field 400, with subfields shown in FIG. 4. This field contains necessary information about the MAC frame. The MAC frame also includes a Duration/ID field 302. Fields 303, 304, 305, and 307 contain addresses. The sequence control field 306 indicates the sequence number of a MAC service data unit (MSDU) or management protocol data unit (MMPDU). The QoS control field 308 contains subfields that define the QoS control functionality. The frame body 309 is a variable length field and contains information specific to individual frame types and subtypes. The frame ends with a frame check sequence field 310 that contains a CRC.

FIG. 4 shows the details of the prior art frame control (FC) field 400. The field includes the following subfields: protocol version 401, type 402, subtype 403, to distributed system (DS) 404, from DS 405, more fragments 406, retry 407, power management 408, more data 409, WEP (wired equivalent privacy) 410, and order 411.

In PCF/HCCA, the AP only polls one STA at a time. Therefore, there is no hidden terminal problem in the network because each STA can only transmit in response to being polled.

Moreover, the AP monitors the activity of the STA on a per poll basis. If the polled STA does not respond to a poll, then the AP immediately polls the next STA in the polling list after a detecting the timeout period. Therefore, the waste of channel resources is negligible.

According to the IEEE 802.11 standard, the polling message can also include an acknowledgment and data. This is called ‘piggybacking’.

Limitation of the Standard Protocol

A major limitation of the polled mechanism used by the IEEE 802.11/11e standard is the low efficiency due to the polling overhead. Moreover, according to the IEEE 802.11e standard, the QoS CF-Poll and CF-Ack frames can only be piggybacked in the polling message when the AP grants another transmission opportunity (TXOP) to the same STA of the previous TXOP. Therefore, the advantage of piggybacking mechanism is not fully realized.

To reduce the overhead, multi-polling has been described. An AP that is a point coordinator/hybrid coordinator (PC/HC) can poll a polling group. The polling group can concurrently include multiple traffic flows, e.g., transmissions of data for different STAs. Each STA in the same polling group initiates its own transmission, in order, after receiving a multi-polling frame. This multi-polling mechanism is called contention-free multi-polling (CF-multi-polling).

In another multi-polling mechanism, the polling order is specified in the time domain, M. Fischer, “QoS Baseline Proposal for the IEEE 802.11E”, IEEE Document 802.11-00/360, November 2000. That is, an individual time interval is assigned for the traffic flow of each STA in the polling group. However, with that mechanism, if a polled STA fails to receive the multi-polling frame or has no data to send, then the time interval allocated to this STA is wasted.

To reduce the failure in receiving the polling frames, a SuperPoll mechanism uses replicated polling frames, A. Ganz and A. Phonphoem, “Robust SuperPoll with Chaining Protocol for IEEE 802.11 Wireless LANs in Support of Multimedia.” In that polling mechanism, each polled STA attaches a polling frame to a transmitted data frame and the polling frame includes the polling message of the remaining polled STAs. However, the redundant polling frames increase overhead.

In S. Lo, G. Lee and W. Chen, “An Efficient Multipolling Mechanism for IEEE 802.11 Wireless LANs,” a contention-based multi-polling mechanism is described to solve the above problems. Although that mechanism improves the efficiency of communication, that multi-polling mechanism is prone to be affected by hidden terminal problem because some stations (STAs) only have partial information of the network and there is no central control after the multi-polling message.

### SUMMARY OF THE INVENTION

An improvement of the IEEE 802.1 In standard requires that throughput of 100 megabits per second (Mbps) or higher is achieved at a medium access control (MAC) layer of an access point (AP). Various polling mechanisms in the current IEEE 802.11 and 802.11e standard entail immense overhead and eventually result in serious performance degradation.

Due to the low protocol efficiency, direct application of the legacy MAC protocol to the IEEE 802.11n standard is not a viable solution.

In order to improve efficiency, reduction in the overhead in the legacy MAC protocol has become very important.

Therefore, the invention provides an enhancement to the proposed IEEE 802.11e standard for HCCA.

The invention uses a multi-polling mechanism to reduce polling and handshaking overhead by disseminating polling information at the beginning of the contention free period (CFP).

During the CFP, the AP polls each STA according to the polling list by a very simple multi-poll frame. Thus, the efficiency of polling is maintained and the hidden terminal problem is avoided. Moreover, the acknowledgement for the previous transmission can be piggybacked with the simple polling message.

### BRIEF DESCRIPTION OF THE DRAWINGS

FIG. 1 is a timing diagram of the prior art IEEE 802.11 standard PCF frame transfer;

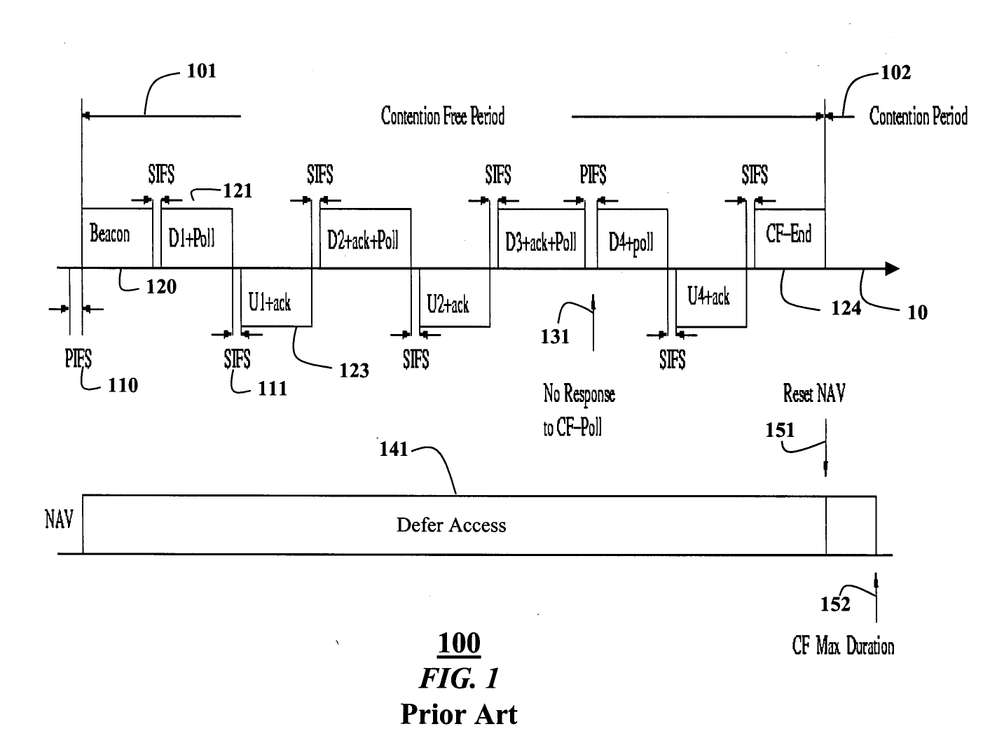

FIG. 2 is a timing diagram of prior art the IEEE 802.11e standard HCCA frame transfer;

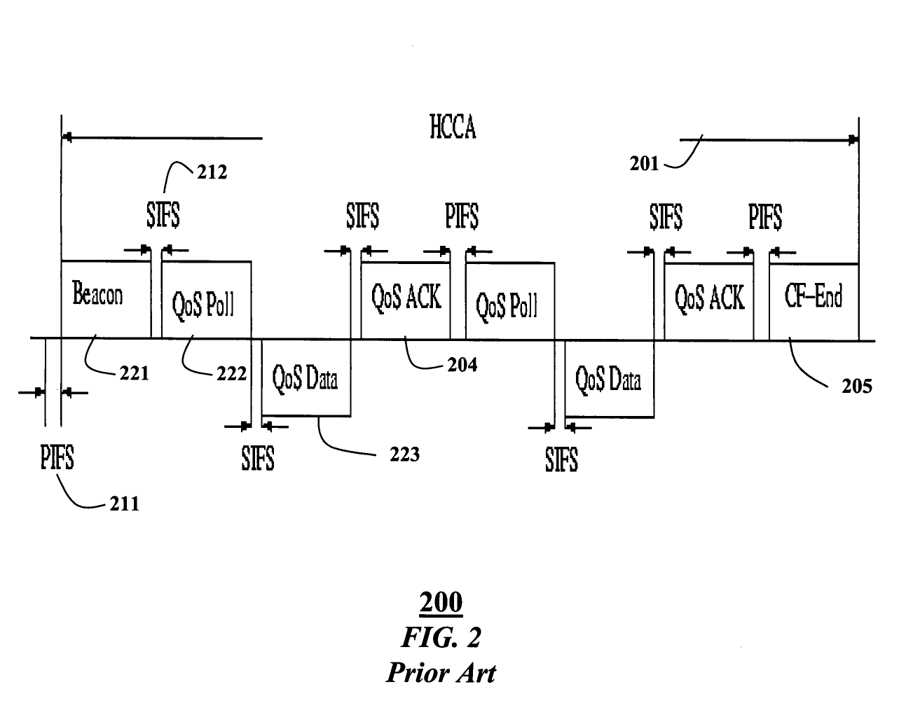

FIG. 3 is a diagram of a prior art MAC frame format;

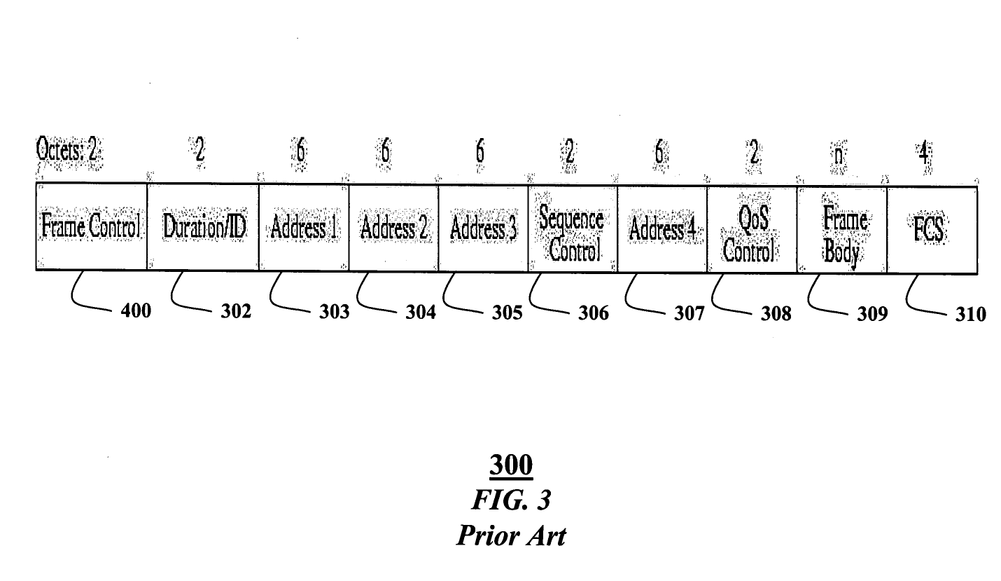

FIG. 4 is a diagram of a prior art frame control field of a MAC frame;

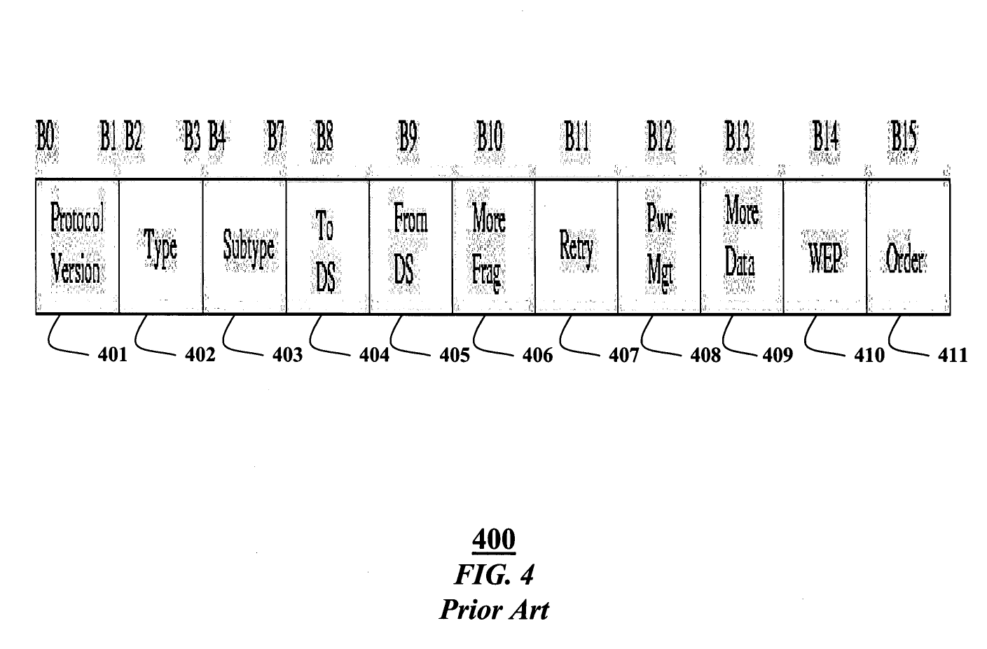

FIG. 5 is a block diagram of a resource allocation frame according to the invention;

FIG. 6 is a block diagram of multi-schedule element subfield of the resource allocation frame of FIG. 5;

FIG. 7 is a block diagram of a multi-poll frame and a multi-poll/QoS CF-ACK frame according to the invention;

FIG. 8 is a block diagram of a network according to the invention; and

FIG. 9 is a block diagram of components of an AP and STA according to the invention.

### DETAILED DESCRIPTION OF THE PREFERRED EMBODIMENT

Network Structure

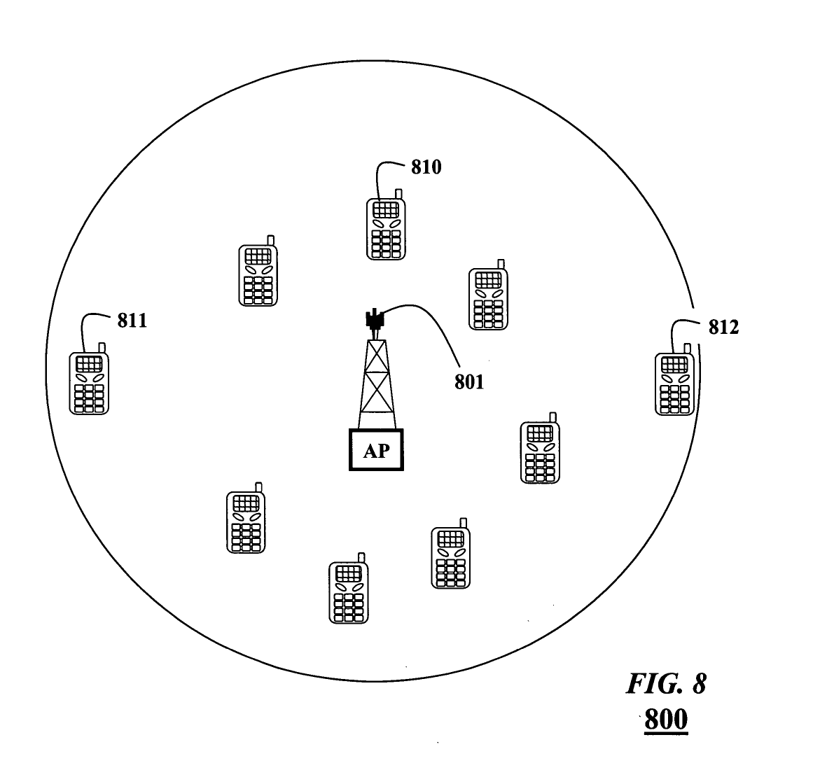

As shown in FIG. 8, the invention provides a multi-polling system and method for a wireless communications network 800 including an access point (AP) 801, e.g., a point coordinator/hybrid coordinator (PC/HC), and multiple transceiver stations STAs 810-812, collectively forming a basic service set (BSS). If some of the stations 810-812 are out of range of each other, then the network may suffer from the so-called ‘hidden terminal’ problem. It is intended to solve this problem.

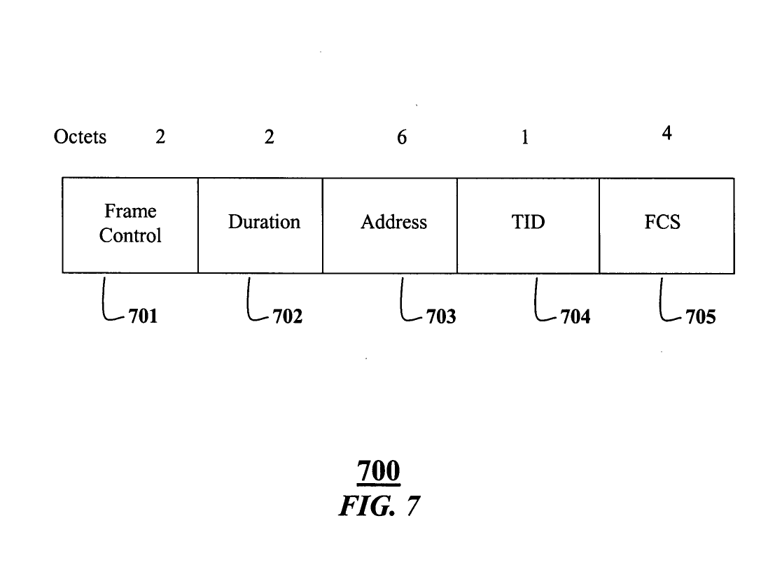

Instead of using a contention-based multi-polling method mechanism with assigned backoff-time or contention-free multi-polling with assigned transmission time durations as in the prior art, STAs according to the invention transmit data only after receiving a multi-poll frame or a multi-poll/QoS CF-ACK frame 700, see FIG. 7.

The multi-polling method according to the invention retains the advantage of both single polling and multi-polling to overcome the hidden terminal problem, and at the same time, maintains a highly efficient polling mechanism.

The underlying idea of the invention is that only the AP has complete information of the BSS. Therefore, the STAs, instead of relying on their own-view of the network, should only trust the information received from the AP, and use the polling information provided by the AP to schedule transmissions. Therefore, the hidden terminal problem is eliminated.

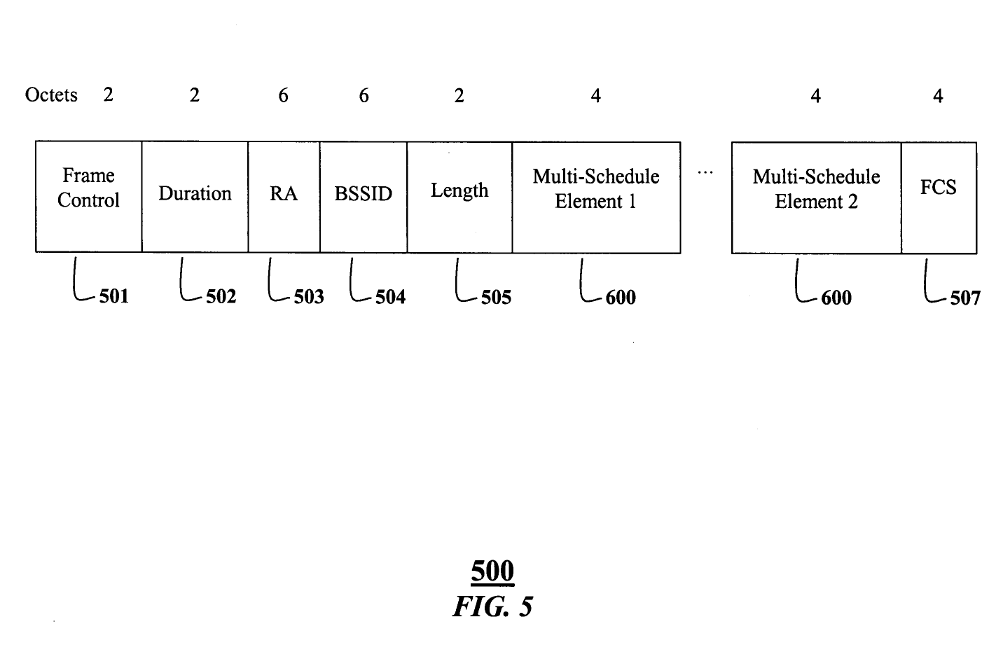

In addition, the multi-polling reduces the overhead of 802.11e because piggyback polling is appropriate. Each STA is assigned a transmission opportunity (TXOP) as indicated in a resource allocation frame (RAL) 500, see FIG. 5, transmitted at the beginning of CFP. Hence, explicit polling with TXOP for each single STA is no longer required.

The multi-polling method operates during the CFP. Specifically, the polling information for all or a group of the STAs is broadcast at the beginning of each CFP in the RAL frame 500, described below. The AP is responsible to poll the next STA in the polling list in the simple multi-poll message 700 to initiate the transmission of the STA.

Each STA retrieves its assigned TXOP in the RAL multi-polling frame at the beginning of the CFP.

A STA accesses the channel only when the STA has been polled by the multi-poll message or a multi-poll/QoS CF-ACK frame. Similar to the conventional IEEE legacy 802.11 standard, implicit acknowledgement is allowed. A STA that receives acknowledgement during a specific period of time after its transmission regards the acknowledgement as intended for the STA. Hence, in the multi-poll poll/QoS CFP-Ack, the polling frame is addressed to the polled STA and implicit acknowledgment is employed for the STA that previously transmitted data.

Frame Formats

Resource Allocation (RAL)

At the start of each CFP, the multi-polling mechanism according to the invention broadcasts polling information for all or a group of STAs associated with the AP using the RAL frame 500.

As shown in FIG. 5, the RAL frame 500, defined in terms of octets of bits, has a control field 501 with a subtype 0111. The frame also includes a duration field 502, a RA field 503, a BSSID field 504, and a FCS field 507. A length field 505 represents the number of multi-schedule element fields 600. All STAs that receive RAL will process it no matter the value of the RA field while the RA field contains the address of the STA that is first polled in the polling list.

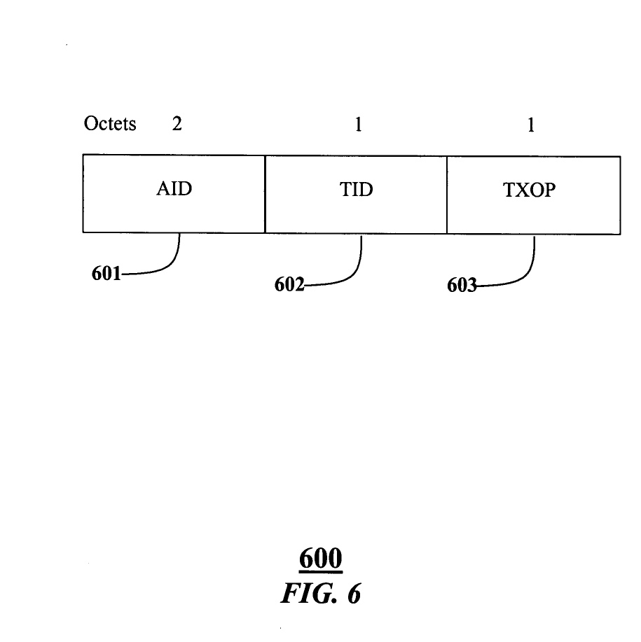

FIG. 6 shows the multi-schedule element field 600 defined in terms of octets. An association ID (AID) field 601 includes the identification of the STA belonging to a particular reservation allocation. The element also includes a traffic identifier (TID) field 602 and a TXOP field 603, which specifies a time granted to the STA in units of 32 microseconds.

The multi-rate support of the RAL frame follows the same rule as blockACK request/reply frames defined in the IEEE 802.11e standard.

Multi-Poll Frames

It is preferred to have a very simple multi-poll frame piggybacked with QoS CF-ACK as newly defined data frames. Because the IEEE 802.11e standard uses all the subtype combinations of data type frame, we use the reserved frame type binary ‘11’ in the type field 402 of the frame control field 400 as ‘multi-poll’ frames.

Table A describes the values for the type field 402 and the subtype field 403. The sub-type field 403 indicates the simple multi-poll and the multi-poll/QoS CF-ACK modes, with subtype value of “1110” indicating a simple polling and subtype value of “1111” representing a polling +QoS CF-ACK as described below.

TABLE A

| Type Value | | Type | Subtype Value | | | | Subtype |
|---|---|---|---|---|---|---|---|
| b3 | b2 | Description | b7 | b6 | b5 | b4 | Description |
| 1 | 1 | Multi-poll | 0 0 0 0-1 1 0 1 | | | | Reserved |
| 1 | 1 | Multi-poll | 1 | 1 | 1 | 0 | Simple Polling |
| 1 | 1 | Multi-poll | 1 | 1 | 1 | 1 | QoS CF-ACK/Polling |

FIG. 7 shows the format for a multi-poll frame 700 defined as octets of bits. The frame includes a frame control field 701, a duration field 702, a receiver address field 703, a TID field 704, and a FCS field 705. Because the multi-poll frame 700 is sent only by the AP, only the address of the polled STA is required. The only difference between simple polling and polling/QoS CF-ACK is the value of subtype field 403.

The multi-rate support of the multi-poll frame follows the same rule as the QoS CF-ACK, QoS CF-Poll frames in the IEEE 802.11e standard, while the overhead has been reduced by 61.1%.

Data Transmission

At the beginning of the CFP, the AP broadcasts the RAL frame 500 containing the multi-polling information 600. Each STA retrieves the TXOP for each traffic identifier (TID) according to the combination of the AID and TID fields. The STA transmits for up to a time TXOP for each specific TID when the STA is polled by the simple multi-poll or multi-poll/QoS CFP-ACK 700. Moreover, the STA with the address equal to the RA field 503 in the RAL frame considers itself being polled, and starts transmission a SIFS time after receiving the RAL frame. Hence, the RAL frame according to the invention also serves as an implicit polling.

For example, a STA S₁ is assigned a TXOP up to three frames transmission. The AP acknowledges the first two frames with the conventional QoS CF-ACK frames. For the last frame, the AP transmits a multipoll/QoS CF-ACK frame 700 to poll the next STA in the polling list, in this case, STA S₂.

STA S₁ considers the received multi-poll/QoS CFP-ACK as implicit acknowledgment for the third frame. This is compatible with the IEEE 802.11 standard.

In response to receiving the multi-poll/QoS CFP-ACK frame 700, STA S₂ starts-transmission a SIFS time after and for duration TXOP for the station S₂. The AP acknowledges STA S₂, and polls the next STA in the polling list, and so on. Eventually, the AP terminates the CFP with the CF-End frame after the last polled STA finishes its transmission.

System Structure

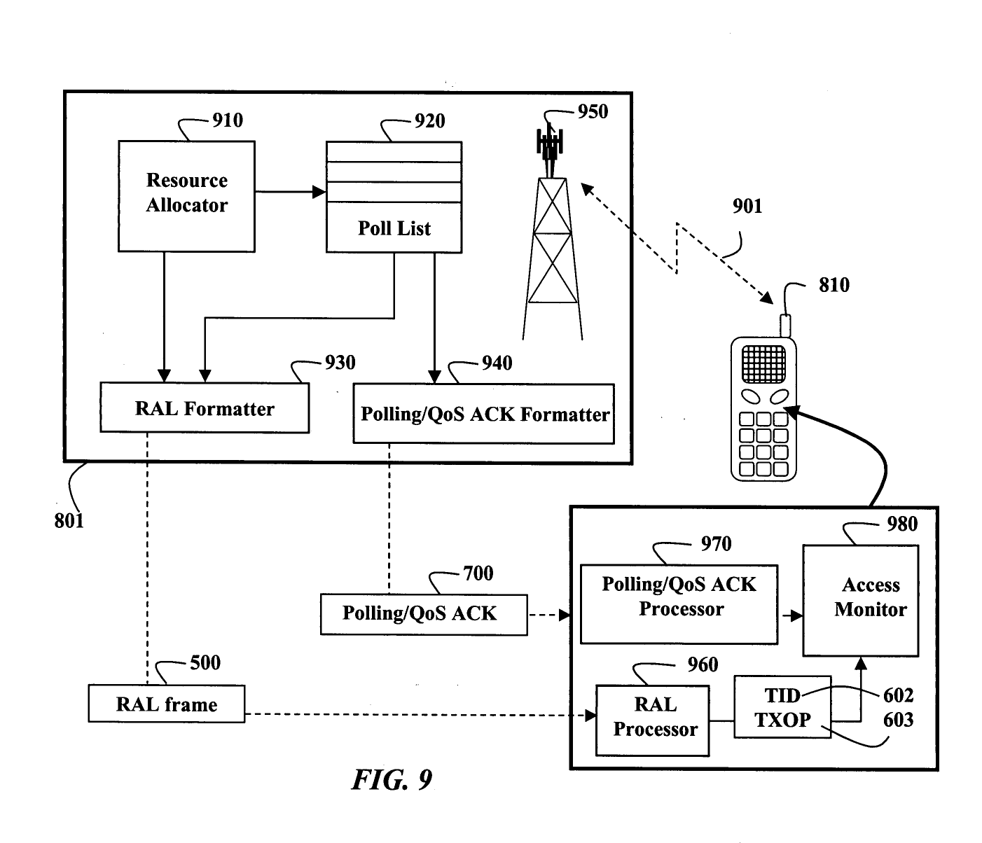

As shown in FIG. 9, the AP 801 includes a resource allocation block (RAL) 910, a poll list 920, a RAL formatter 930, a polling/QoS CF-ACK formatter block 940, and a transceiver 950.

A STA 810 includes a RAL processor 960, a polling/QoS ACK processor 970 and an access monitor block 980. It is understood that the station 810 communicates 901 with the AP 801 via a transceiver 950.

System Operation

The AP 801 formats 930 the RAL frame according to the polling list 920 and broadcasts the RAL frame 500 to STAs at the beginning of CFP. The polling/QoS ACK formatter 940 generates polling/QoS ACK frames 700 to poll a next STA in the polling list, and implicitly acknowledge a previous transmission.

In the STA 810, the RAL processor 960 extracts the TID 602 and TXOP 603 associated with the STA from the appropriate multi-schedule element 600 of the RAL frame 500. The TID and TXOP are passed to the access monitor 980. In response to receiving the polling/QoS ACK frame 700, the polling/QoS ACK processor 970 determines whether the STA can access the channel and controls the access monitor accordingly.

Effect of the Invention

Compared to the IEEE 802.11e standard, the invention improves the efficiency of polling in a network by using multi-polling. The invention also eliminates the hidden terminal problem, which is intrinsic in conventional multi-polling mechanism that utilize time slots for STAs to defer and backoff, because the access point has the comprehensive information of the network. Furthermore, the multi-polling according to the invention is compatible with the current IEEE 802.11 standard.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for accessing a wireless channel in a communications network including a plurality of stations and an access point connected by the wireless channel, comprising:
broadcasting, from an access point, polling information indicating when a plurality of stations can transmit; and
polling a next station in an acknowledgement message broadcast by the access point in response to receiving data transmitted by a previously polled station.

2. The method of claim 1, in which a time to transmit is partitioned into alternating contention free periods and contention periods, and further comprising:
broadcasting the polling information only at a beginning of the contention free period.

3. The method of claim 1, in which the polling information is broadcast in a resource allocation frame including a multi-polling field for each of the plurality of stations, each multi-polling field including an identification of the station, an identification of a traffic flow from the station, and a transmit opportunity time.

4. The method of claim 1, in which the resource allocation frame includes a length field indicating a number of the stations to be polled.

5. The method of claim 4, in which each station transmits data to the access point during the associated transmit opportunity time for the station.

6. The method of claim 3, in which an acknowledgement message includes a frame control type field, a subtype field, the identification of the next station, and the identification of the traffic flow.

7. The method of claim 1, further comprising:
acknowledging implicitly the received data.

8. The method of claim 1, further comprising:
polling explicitly the next station using an address in a resource allocation frame including the polling information.

9. A wireless communications network, comprising:
an access point configured to broadcast polling information on a channel of a wireless communications network;
a plurality of stations configured to receive the polling information;
and indicating when a plurality of stations can transmit; and
means for polling a next station of the plurality of stations in an acknowledgement message broadcast by the access point in response to receiving data transmitted by a previously polled station.
